(19) United States
(12) Patent Application Publication
(10) Pub. No.: US 2016/0026323 A1
(43) Pub. Date: Jan. 28, 2016

(54) HAND-HELD ELECTRONIC DEVICE, TOUCH-SENSING COVER AND INITIATION METHOD WITH FUNCTION OF MULTI-TOUCH

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/710,055

(22) Filed: May 12, 2015

(30) Foreign Application Priority Data
Jul. 25, 2014 (CN) 201410360104.3

(51) Int. Cl. G06F 3/041; G06F 3/044; G09G 5/00

(52) U.S. Cl. CPC G06F 3/0416; G09G 5/003; G06F 3/044; G09G 2300/0426

(57) ABSTRACT

A touch-sensing cover for hand-held electronic device includes a cover and a touch-sensing structure. The cover is disposed on the other side of the hand-held electronic device opposite to the panel. The touch-sensing structure with its partial or full area is disposed on the cover and has a plurality of detective points to receive a trigger event triggering part of the detective points. The touch-sensing structure includes a first sensing layer having a plurality of first sensing lines. The first sensing lines include the detective points and are coupled to a capacitance detection unit. While the trigger event conforms with an initiative determination condition stored in the hand-held electronic device, the capacitance detection unit detects or starts to detect a plurality of the touch events occurring simultaneously at distinct positions on the cover, and generates a plurality of signals representing the positions where the respective touch events occur.

### CROSS REFERENCE TO RELATED APPLICATIONS

This Non-provisional application claims priority under 35 U.S.C. §119(a) on Patent Application No(s). 201410360104.3 filed in China on Jul. 25, 2014, the entire contents of which are hereby incorporated by reference.

### BACKGROUND

1. Technical Field

The invention relates to a hand-held electronic device, a touch-sensing cover and an initiation method with multi-touch function, and in particular to a hand-held electronic device, a touch-sensing cover and an initiation method which solves the problem of shading the display panel due to touch operation.

2. Related Art

Recently, touch technique has been widely applied to general consuming electronic devices, for example, smart phone, tablet computer, PDA (personal digital assistants), GPS (global positioning system) navigation device, etc. In comparison with conventional input manners such as mouse or keyboard, the touch technique utilizes human fingers instead of mouse or keyboard or other hardware devices, and it is friendly and intuitive operation manner and operation interface. Thus, many users like to utilize touch technique to operate various electronic devices. Multi-touch technique initiates a revolutionary development for touch technique.

As to the well-known hand-held electronic devices with multi-touch function, operations are directly performed on the panel. For example, U.S. Pat. No. 7,663,607 of Apple Corp. discloses a “Multipoint touchscreen” wherein the user mainly uses fingers to perform multi-touch operation on the display surface of the touch panel and it needs to introduce the transparent touch-sensing layer. But when operating on the panel, fingers will shade the user's view or the software target displayed by the panel. Thus, fingers may inadvertently cause problems of opening the link due to high information content density on the display panel. These problems become more serious during multi-touch by the user. Furthermore, when the user uses the hand-held electronic device under the sun, the sunlight visibility of the panel is still an ineffectively unsolved problem. Because the user can not see the information on the panel under sun, he does not operate by his two hands to timely and effectively click to reply to an e-mail or facebook information.

In addition, the aforementioned panel needs to introduce the transparent touch-sensing structure of rare earth element such as ITO (indium tin oxide) in order to make the panel capable of both touch control and display performance. But restricted from the gradual depletion of rare earth element indium and problems of soaring costs and less conduction than metal, it is not an effective way to always employ rare earth element indium to manufacture the transparent touch-sensing structure.

In addition, because a finger or stylus needs to contact the touch panel for controlling or operating the electronic device, it often scratches the panel. Besides, when operating well-known hand-held electronic device with touch control function, it usually requires one hand to hold the hand-held electronic device and the other hand to operate on the panel. If the user only uses his one hand to hold and operate the device, only his thumb can manipulate the device and thus reduce efficiency and convenience of manual operation.

Therefore, a hand-held electronic device, a touch-sensing cover and an initiation method with multi-touch function which can solve the problem shading the display panel due to touch operation, in the meantime perform multi-touch function, strengthen user privacy protection, for example the password will not be peeped by others behind the user when inputting it, reduce the cost of the touch-sensing structure, improve efficiency, safety and operational convenience, and to achieve better quality and user experience.

### SUMMARY

An aspect of the invention is to provide a hand-held electronic device, a touch-sensing cover and an initiation method with multi-touch function, which solve the problem shading the display panel due to touch operation and have capability of multi-touch function, and improve efficiency and convenience of manual operation. The invention is also to provide a design around against U.S. Pat. No. 7,663,607 of Apple Corp. to lift concerns of patent infringement and create for users better optimized user experience than Apple's products and technologies.

Another aspect of the present invention is to provide a touch-sensing cover for hand-held electronic device. The hand-held electronic device includes the touch-sensing cover, a panel and a control unit. The touch-sensing cover includes a cover and a touch-sensing structure. The cover is disposed on the other side of the hand-held electronic device opposite to the panel. The touch-sensing structure with its partial or full area is disposed on the cover and has a plurality of detective points to receive a trigger event. The trigger event triggers part of the detective points. The touch-sensing structure includes a first sensing layer. The first sensing layer has a plurality of first sensing lines. The first sensing lines include the detective points and are coupled to a capacitance detection unit. If the trigger event conforms with an initiative determination condition stored in the hand-held electronic device, the capacitance detection unit detects or starts to detect a plurality of the touch events occurring simultaneously at distinct positions on the cover, and generates a plurality of signals representing the positions where the respective touch events occur.

In one embodiment, the touch-sensing structure further includes a second sensing layer disposed separately from the first sensing layer in space. The second sensing layer has a plurality of second sensing lines, and the first sensing lines and the second sensing lines are respectively interlaced to form the detective points.

In one embodiment, the first sensing layer further includes a first substrate, the first sensing lines are disposed on the first substrate, the second sensing layer further includes a second substrate, and the second sensing lines are disposed on the second substrate.

In one embodiment, the first sensing lines are disposed on the cover, and there is an insulation layer between the first sensing layer and the second sensing layer.

In one embodiment, the touch-sensing structure includes a metal mash, a metal nanowire, a conductive film, a carbon nanotube and graphene.

Therefore, a hand-held electronic device according to the invention includes a panel, a control unit and a touch-sensing cover are provided. The control unit is electrically connected to the panel. The touch-sensing cover is electrically connected to the control unit. The touch-sensing cover includes a cover and a touch-sensing structure. The cover is disposed on the other side of the hand-held electronic device opposite to the panel. The touch-sensing structure with its partial or full area is disposed on the cover and has a plurality of detective points to receive a trigger event. The trigger event triggers part of the detective points. The touch-sensing structure includes a first sensing layer. The first sensing layer has a plurality of first sensing lines. The first sensing lines include the detective points and are coupled to a capacitance detection unit. If the trigger event conforms with an initiative determination condition stored in the hand-held electronic device, the capacitance detection unit detects or starts to detect a plurality of the touch events occurring simultaneously at distinct positions on the cover, and generates a plurality of signals representing the positions where the respective touch events occur.

In one embodiment, the control unit computes the trigger quantity distribution, trigger time, trigger frequency, trigger morphology (which can refer to trigger appearance) or trigger location (which can refer to trigger position) of the part of the detective points triggered by the trigger event to generate a computational result.

In one embodiment, the control unit determines whether if the trigger quantity distribution, trigger time, trigger frequency, trigger morphology or trigger location conforms with the initiative determination condition according to the computational result.

In one embodiment, the touch-sensing structure further includes a second sensing layer disposed separately from the first sensing layer in space, the second sensing layer has a plurality of second sensing lines, and the first sensing lines and the second sensing lines are respectively interlaced to form the detective points.

In one embodiment, the first sensing layer further includes a first substrate, the first sensing lines are disposed on the first substrate, the second sensing layer further includes a second substrate, and the second sensing lines are disposed on the second substrate.

In one embodiment, the touch-sensing structure includes a metal mash, a metal nanowire, a conductive film, a carbon nanotube and graphene.

In one embodiment, a user operates the hand-held electronic device by one hand, and the touch-sensing cover faces a light source or the back of the panel faces the light source.

In one embodiment, the wires connected to the touch-sensing structure are concentrated in an outlet of one side.

In one embodiment, the width of the touch-sensing structure is slightly narrower than the width of the touch-sensing cover about 5% to 10%.

In one embodiment, the area of the touch-sensing structure has a ratio relationship to the area of the panel, and the control unit changes an input position of the touch-sensing structure to a display position of the panel according to the ratio relationship.

In one embodiment, the first sensing layer or the second sensing layer is capable of wireless power transmission.

In one embodiment, the touch-sensing cover further includes a near field communication unit, the near field communication unit has a near field communication chip and an antenna, the near field communication chip is electrically connected to the control unit, and the antenna is disposed on the cover or the touch-sensing structure.

Therefore, a method for initiating multi-touch function according to the invention is adapted for a hand-held electronic device. The hand-held electronic device includes a panel, a touch-sensing cover and a control unit. The touch-sensing cover has a cover and a touch-sensing structure. The touch-sensing structure has a plurality of detective points and is coupled to a capacitance detection unit. The method executed on the hand-held electronic device includes the steps of: receiving a trigger event by the touch-sensing structure, wherein the trigger event triggers part of the detective points of the touch-sensing structure; determining whether the trigger event conforms with the initiative determination condition stored in the hand-held electronic device by the control unit; and while the trigger event conforms with the initiative determination condition, detecting a or starting to detect plurality of the touch events occurring simultaneously at distinct positions on the cover and generating a plurality of signals representing the positions where the respective touch events occur by the capacitance detection unit.

In one embodiment, the method further includes utilizing the control unit to compute the trigger quantity distribution, trigger time, trigger frequency, trigger morphology or trigger location of the part of the detective points triggered by the trigger event to generate a computational result.

In one embodiment, the control unit determines whether the trigger quantity distribution, trigger time, trigger frequency, trigger morphology or trigger location conforms with the initiative determination condition according to the computational result.

In summary, the touch-sensing cover according to the invention includes the cover and the touch-sensing structure, and the touch-sensing structure is disposed on the cover and includes a first sensing layer. The first sensing layer has a plurality of first sensing lines which include the detective points and are coupled to a capacitance detection unit. The touch-sensing structure receives a trigger event, and the trigger event triggers part of the detective points. While the trigger event conforms with an initiative determination condition stored in the hand-held electronic device, the capacitance detection unit detects or starts to detect a plurality of the touch events occurring simultaneously at distinct positions on the cover, and generates a plurality of signals representing the positions where the respective touch events occur. Thus the multi-touch function is implemented.

By determining whether the trigger event conforming with an initiative determination condition and then accordingly initiating the multi-touch function, it can prevent the hand-held electronic device from being unlocked and misappropriation by others. It also improves safety by the trigger event as identification.

In addition, benefiting from the touch-sensing cover, the user can avoid performing touch operation on the display surface of the panel, so that the display panel and the software target displayed by the panel will not be shaded by user's fingers, and the user will not inadvertently suffer problems of opening the link due to high information content density on the display panel. Regardless of the user viewing the complete screen content to improve visual quality, the password will not be peeped by others behind the user when inputting it. It reduces the cost of the touch-sensing structure, and improves efficiency, safety and operational convenience. It achieves better quality and user experience, and prevents the panel from being scratched by stylus.

Furthermore, when the user uses the hand-held electronic device under the sun, he can hold the hand-held electronic device just by his single hand and use the touch-sensing cover to block the sunlight or light source. Due to the panel information resulting from the touch-sensing cover which blocking the sunlight, the sunlight visibility of the panel is improved, and it can be implemented without advanced OLED or electric paper display panel technique. In addition, because the user can just use single hand to operate or input respect to the panel information on the touch-sensing cover, it enhances safety of the hand-held electronic device and convenience of operation by single hand under the sun.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic diagram showing the hand-held electronic device according to one embodiment of the invention;

FIG. 2 is a block diagram showing the function of the hand-held electronic device in FIG. 1;

FIG. 3A is a schematic diagram showing another example of the touch-sensing structure in FIG. 2;

FIG. 3B is a schematic diagram showing another example of the touch-sensing structure in FIG. 2;

FIG. 4 is a schematic diagram showing the touch-sensing structure according to another embodiment of the invention;

FIG. 5A is a sectional schematic diagram showing the touch-sensing structure at sectional line A-A in FIG. 4;

FIG. 5B is a schematic diagram showing another example of the touch-sensing structure in FIG. 4;

FIG. 6 is a block diagram showing the function of the touch-sensing structure in FIG. 5A or FIG. 5B;

FIG. 7 is a flow chart showing the steps of the method for initiating multi-touch function according to one embodiment of the invention;

FIG. 8A is a schematic diagram showing the trigger event according to one embodiment of the invention; and

FIG. 8B is a schematic diagram showing the trigger event in FIG. 8A corresponding to the touch-sensing structure in FIG. 4.

### DETAILED DESCRIPTION OF THE INVENTION

The embodiments of the invention will be apparent from the following detailed description, which proceeds with reference to the accompanying drawings, wherein the same references relate to the same elements.

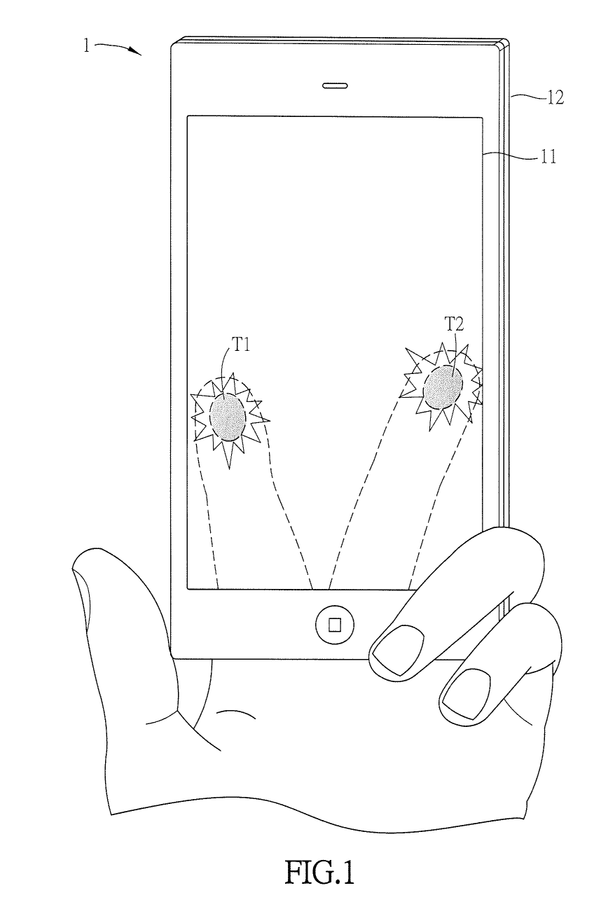

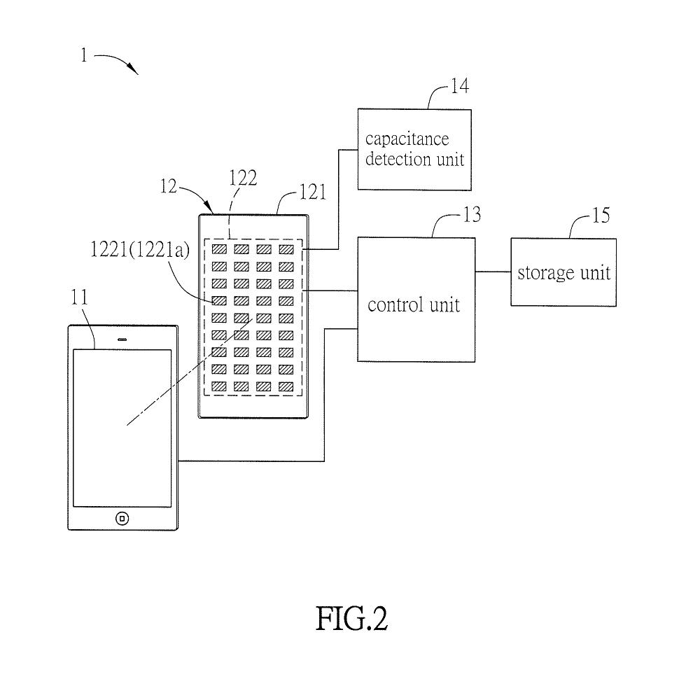

FIG. 1 is a schematic diagram showing the hand-held electronic device 1 according to one embodiment of the invention. FIG. 2 is a block diagram showing the function of the hand-held electronic device 1 in FIG. 1. Referring to FIG. 1 and FIG. 2, the hand-held electronic device 1 includes a panel 11, a touch-sensing cover 12 and a control unit 13. In the embodiment, the hand-held electronic device 1 may be a smart phone, a tablet computer, a PDA (personal digital assistants), a GPS (global positioning system) navigation device, etc. Here, the hand-held electronic device 1 is a smart phone for example.

The panel 11 is disposed on one side of the hand-held electronic device 1, for example the closer side of the hand-held electronic device 1 to the user's view. The panel 11 may include a display panel, namely, a panel with display function or a touch display panel with both display function and touch control function. Regardless of displaying general screen, the panel 11 may also provide the user with GUI (graphical user interface).

The touch-sensing cover 12 is disposed on the other side of the hand-held electronic device 1 opposite to the panel 11, for example the farther side of the hand-held electronic device 1 to the user's view. The touch-sensing cover 12 provides the user with the touch input manner, and he may further interact with the GUI on the panel 11. Here, for example, the touch control is implemented while the user makes a contact or an approach almost contact by his finger or other touch device. The interaction with the GUI for example may be that the user uses his finger on the touch-sensing cover 12 at a position corresponding to the icon displayed by the panel 11 to click, enlarge or move it in touch control manner. In the embodiment, the touch-sensing cover 12 is preferably non-transparent.

Besides, when the user uses the hand-held electronic device 1 under the sun, he can hold the hand-held electronic device 1 just by his single hand and take the touch-sensing cover 12 face the light source to block the sunlight or light source. Because the opposite position of the panel 11 faces to the light source, the information displayed by it benefits from the touch-sensing cover 12 blocking the sunlight, and thus the sunlight visibility of the panel 11 is improved. The user can just use single hand to operate or input respect to the panel information on the touch-sensing cover. It enhances safety of the hand-held electronic device and convenience of operation by single hand under the sun.

The control unit 13 is electrically connected to the panel 11 and the touch-sensing cover 12. In the embodiment, the control unit 13 can be disposed on the circuit board within the hand-held electronic device 1. The control unit 13 controls not only the content displayed by the panel 11, but it also controls the relating operations of the touch-sensing cover 12. These will be explained in the later description.

The touch-sensing cover 12 includes a cover 121 and a touch-sensing structure 122. The touch-sensing structure 122 has a plurality of detective points, and it with its partial or full area is disposed on the cover 121. In order to effectively utilize the width of the cover 121 to allocate the touch-sensing structure 122, the width of the touch-sensing structure 122 is slightly narrower than the width of the cover 121 (for example about 5% to 10%). Namely, the width of the touch-sensing structure 122 is about 90% to 95% of the width of the cover 121. The touch-sensing structure 122 may also yield to the position of the camera lens or the flash of the cover 121, so the touch-sensing structure 122 is not disposed on a local region of the cover 121 (namely the position of the camera lens or the flash).

In the embodiment, the touch-sensing structure 122 can be disposed not only the inner surface of the cover 121 facing the panel 11, and also the lateral side of the cover 121. The touch-sensing structure 122 includes a plurality of first sensing lines 1221a, and they are disposed coplanarly to form a first sensing layer 1221. Here, the first sensing lines 1221a are not limited to rectangular, and they may also be long strip, diamond, round or other shapes. The touch-sensing structure 122 may include a metal mash, a metal nanowire, a conductive film, a carbon nanotube, graphene, or other conductive material. When the touch-sensing structure 122 employs a metal mash, it can alleviate Moire phenomenon and reduce material cost, and its linewidth is not restricted to transparency demand.

Besides, when the touch-sensing structure 122 is made by the metal mash, because the touch-sensing structure 122 can be disposed on the outer surface (non-display surface) of the cover 121, it exhibits metallic impression. Therefore, for example, it looks like a metallic cover by disposing the touch-sensing structure 122 made by the metal mesh on the outer surface (non-display surface) of the cover 121 of non-metallic material. Thus, it is not necessary to adopt the metal cover (manufacturing process is more complicated) and the cost is further reduced.

Besides, the area of the touch-sensing structure 122 in the embodiment has a ratio relationship to the area of the panel 11. The ratio relationship will be utilized by the control unit 13 to change a touch position of the touch-sensing cover 12 to a corresponding position of the panel 11. In one embodiment, the area of the touch-sensing structure 122 may be smaller than the area of the panel 11. Alternatively in other embodiment, the area of the touch-sensing structure 122 may be equal to (even larger than) the area of the panel 11. When the touch-sensing structure 122 covers the lateral side of the touch-sensing cover 12, the area of the touch-sensing structure 122 may be larger than the area of the panel 11.

For example, when the user uses his finger on the touch-sensing cover 12 to perform touch operation, the panel 11 may display the corresponding operation instruction according to the posture (or called gesture) of the user operation. The control unit 13 changes an input position of the touch-sensing structure 122 to a display position of the panel 11. The panel 11 will display an eye-catching prompt and interact with the GUI displayed on the panel 11.

For example, when the user slides his finger over the touch-sensing cover 13, the panel 11 also has a corresponding cursor (for example an arrow or a hand shape) which accordingly slides at corresponding positions. Here, for example, the touch control is implemented while the user makes a contact or an approach almost contact by his finger or stylus. Besides, the interaction with the GUI for example may be that the user uses his finger on the touch-sensing cover 12 to click, enlarge or move it in touch control manner. For example, when the user's finger knock slightly at the touch-sensing cover 12, the panel 11 will drag the object of information of the corresponding position. Thus, it is not necessary to operate on the panel 11 of the hand-held electronic device 1 of the invention, directly controlling on the touch-sensing cover 12 will have similar effect in comparison to operating on the panel.

Besides, a circuit board, a battery or a memory card may be further included between the touch-sensing cover 12 and the panel 11.

Besides, the wires connected to the touch-sensing structure 122 are concentrated in an outlet of one side, and then electrically connected to the circuit for spreading the design flexibility of circuit lines.

In the embodiment, the first sensing lines 1221a are electrically isolated from each other and disposed on the cover 121, and the electrically isolated first sensing lines 1221a represent distinct detective points. The first sensing lines 1221a are coupled to a capacitance detection unit 14. Here, the term “coupled” may refer to electrical connection by direct manner or electrical connection by indirect manner. Here, the first sensing lines 1221a are directly electrically connected to the capacitance detection unit 14 through the circuit for example.

Actually, while the user makes a contact or an approach almost contact with the specific first sensing line 1221a by his finger, the finger will change the capacitance of the first sensing line 1221a. By utilizing the capacitance detection unit 14 to simultaneously detect or start to detect the capacitance variation of all the first sensing lines 1221a, it can determine the position where a contact of the user's finger.

In the embodiment, the touch-sensing cover 12 may perform touch control not only in single point mode, but it also can receive multi-touch operations. The term “multi-touch” means that a plurality of touch evens occur simultaneously at distinct positions. Namely, the touch-sensing cover 12 allows it to simultaneously generate and to simultaneously detect or start to detect the touch events T1, T2 (as shown if FIG. 1) occurring at distinct positions, and to generate a plurality of signals representing the positions where the respective touch events occur.

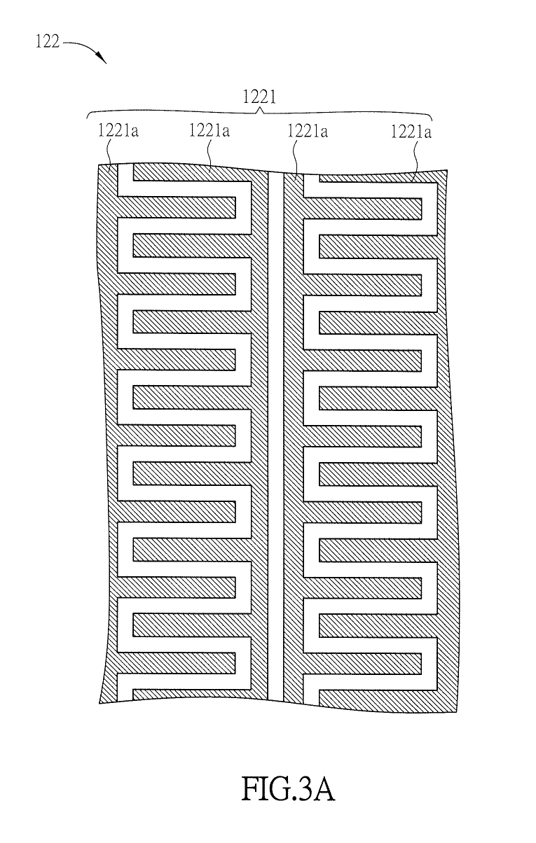

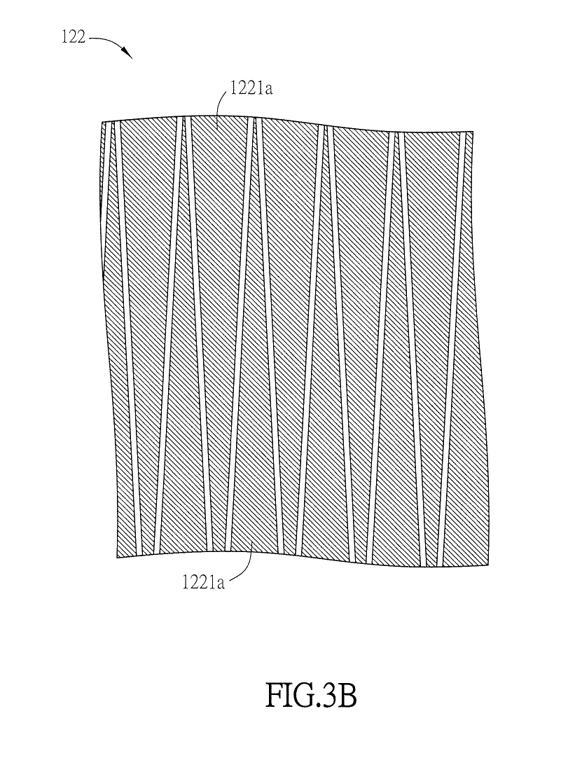

FIG. 3A is a schematic diagram showing another example of the touch-sensing structure 122 in FIG. 2. Referring to FIG. 3A, the difference from FIG. 2 is that in the embodiment, the first sensing lines 1221a are like a comb, and they are disposed coplanarly on the cover 121. FIG. 3B is a schematic diagram showing another example of the touch-sensing structure 122 in FIG. 2. Referring to FIG. 3B, in the embodiment, the first sensing lines 1221a is like a triangle, and they are disposed parallelly and coplanarly on the cover 121. Because other details can refer to the previous explanation, they are not repeated again here.

In other embodiment of the invention, the touch-sensing structure may be a single-layered electrode structure. For example, the touch-sensing structure may include a plurality of sensing pads that are formed simultaneously, and the sensing pads may be in the form of a single layer structure. The sensing pads may be a transparent conductive layer or a metal mesh. The shape of the sensing pad includes, but not limited to, a diamond shape or triangle, as long as they can help to achieve touch-sensing operations. Moreover, all sensing pads are not needed to have an identical shape.

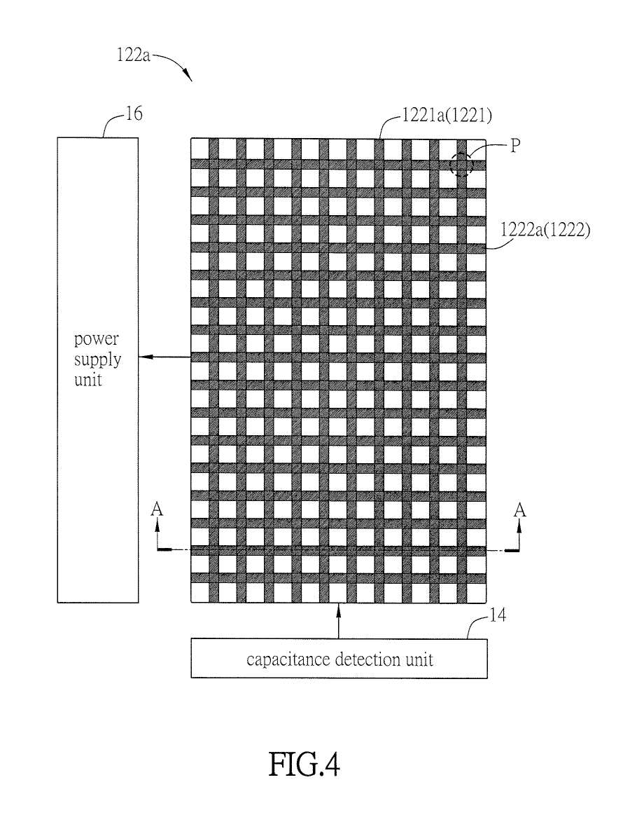

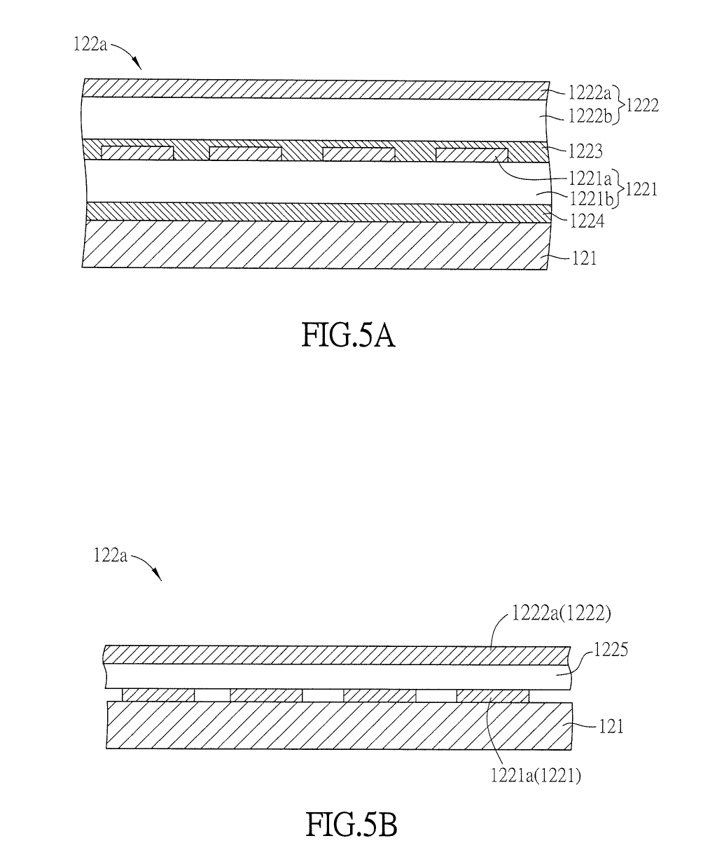

FIG. 4 is a schematic diagram showing the touch-sensing structure according to another embodiment of the invention. FIG. 5A is a sectional schematic diagram showing the touch-sensing structure 122a at sectional line A-A in FIG. 4. Referring to FIG. 4 and FIG. 5A, the difference from the previous embodiment (FIG. 2, the touch-sensing structure 122) is that the touch-sensing structure 122a further includes a plurality of second sensing lines 1222a, and they are disposed coplanarly to form a second sensing layer 1222. The first sensing layer 1221 and the second sensing layer 1222 are separately disposed, and they together form mutual capacitance touch-sensing structure. Specifically, the first sensing layer 1221 and the second sensing layer 1222 are located at distinct planes in space. The touch-sensing structure 122a may include a metal mash, a metal nanowire, a conductive film, a carbon nanotube, graphene, or other conductive material. When the touch-sensing structure 122a employs a metal mash, it can alleviate Moire phenomenon and reduce material cost, and its linewidth is not restricted to transparency demand

When employing a metal mash, a metal nanowire or graphene as the material of the first sensing layer 1221 and the second sensing layer 1222, the first sensing layer 1221 or the second sensing layer 1222 can be further utilized to perform wireless power transmission (for example wireless charging).

In the embodiment, the first sensing layer 1221 may further include a first substrate 1221b, and the first sensing lines 1221a are disposed on the first substrate 1221b. The second sensing layer 1222 may further include a second substrate 1222b, and the second sensing lines 1222a are disposed on the second substrate 1222b. Actually, these sensing lines can be formed on these substrates by lithography and etching. Here, the shapes and the quantities of the first sensing lines 1221a and the second sensing lines 1222a are not limited, and their shape may respectively be rectangular, long strip, diamond, round or other shapes. The quantity of the first sensing lines 1221a and the quantity of the second sensing lines 1222a may be the same or different.

In the embodiment, the first substrate 1221b and the second substrate 1222b can be attached to each other by a connecting layer 1223. The connecting layer 1223 may be for example an OCA (optical clear adhesive) to strengthen the structure therein. In addition, the first substrate 1221b may further be attached to the cover 121 by an adhesive layer 1224. The adhesive layer 1224 for example is also an OCA.

Referring to FIG. 4 again, in the embodiment, the first sensing lines 1221a and the second sensing lines 1222a are respectively interlaced to form a plurality of detective points P. Actually, each of the first sensing lines 1221a and each of the second sensing lines 1222a can be interlaced orthogonally, almost orthogonally or non-orthogonally. The detective point P is located at an interlaced position of each of the first sensing lines 1221a and each of the second sensing lines 1222a. In the embodiment, the first sensing lines 1221a and the second sensing lines 1222a are orthogonal to each other for example, and the respective detective points P corresponds to distinct positions on the cover 121.

In the embodiment, the first sensing lines 1221a are coupled to the capacitance detection unit 14, and the second sensing lines 1222a are coupled to a power supply unit 16. The power supply unit 16 provides a voltage signal for the second sensing lines 1222a. Because the first sensing lines 1221a and the second sensing lines 1222a are very close and both they are conductive, a charge coupling occurs at the interlaced position (the detective point P) between each of the first sensing lines 1221a and each of the second sensing lines 1222a. When the user makes a contact or an approach almost contact by his finger on the detective point P, the finger will change the charge coupling which occurs at the detective point P between the first sensing line 1221a and the second sensing line 1222a, and thus influencing the capacitance of the detective point P. Therefore, the capacitance detection unit 14, which is electrically connected to the first sensing lines 1221a, can accordingly detect or start to detect the capacitances of all the detective points P to determine the touch position on the touch-sensing cover 12 by the finger.

FIG. 5B is a schematic diagram showing another example of the touch-sensing structure 122a in FIG. 4. The difference from the previous example (FIG. 5A) is that in this example, the first sensing lines 1221a are directly disposed onto the cover 121, and there is an insulation layer 1225 between the first sensing layer 1221 and the second sensing layer 1222. This configuration has an advantage of thinness.

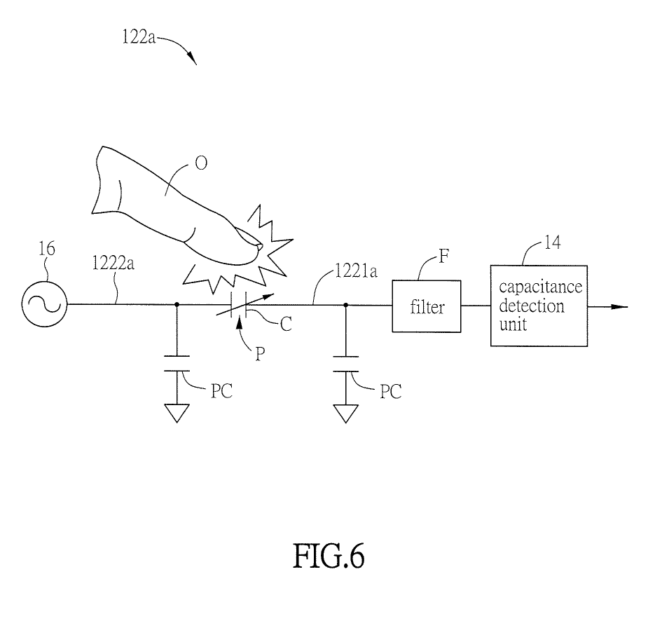

FIG. 6 is a block diagram showing the function of the touch-sensing structure 122a in FIG. 5A or FIG. 5B. Referring to FIG. 6, the first sensing lines 1221a and the second sensing lines 1222a form the detective points P at their interlaced positions. Resulting from that the power supply unit 16 provides currents for the second sensing lines 1222a, a charge coupling C occurs at the position of the detective point P. The capacitance of the charge coupling C keeps constant if it is not influenced by other objects. However, when the user makes a contact or an approach almost contact by his finger O, it will influence and change the capacitance of the charge coupling C, and the capacitance detection unit 14 can accordingly determine the position where the finger contacts. Because the capacitance detection unit 14 can simultaneously correspond to all the detective points P, the touch-sensing cover 12 in the embodiment can have capability of multi-touch function. Because other details related to the first sensing lines 1221a and the second sensing lines 1222a can refer to the previous explanation, they are not repeated again here.

In the embodiment, a filter F is further included between the first sensing lines 1221a and the capacitance detection unit 14, and it may be implemented for example by an inverting amplifier. The filter F is applied to eliminate the parasitic capacitance PC, for example, capacitive effects between the distinct first sensing lines 1221a, capacitive effects between the distinct second sensing lines 1222a or capacitive effects between each electrode and the ground. By the filter F, the signal input to the capacitance detection unit 14 will not be influenced by the capacitances at locations other than the detective point P.

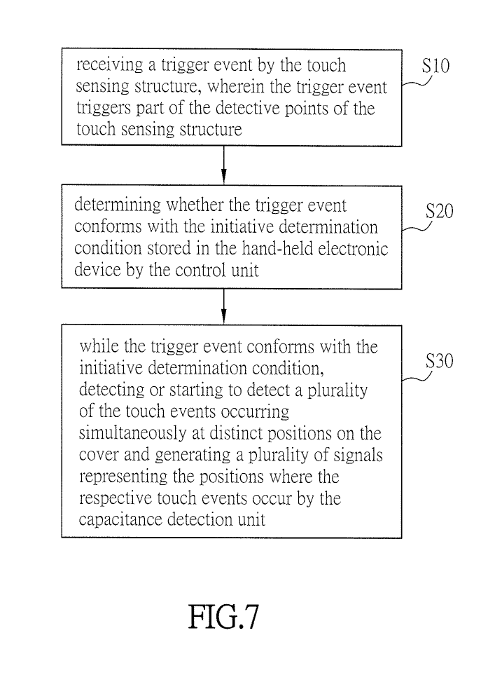

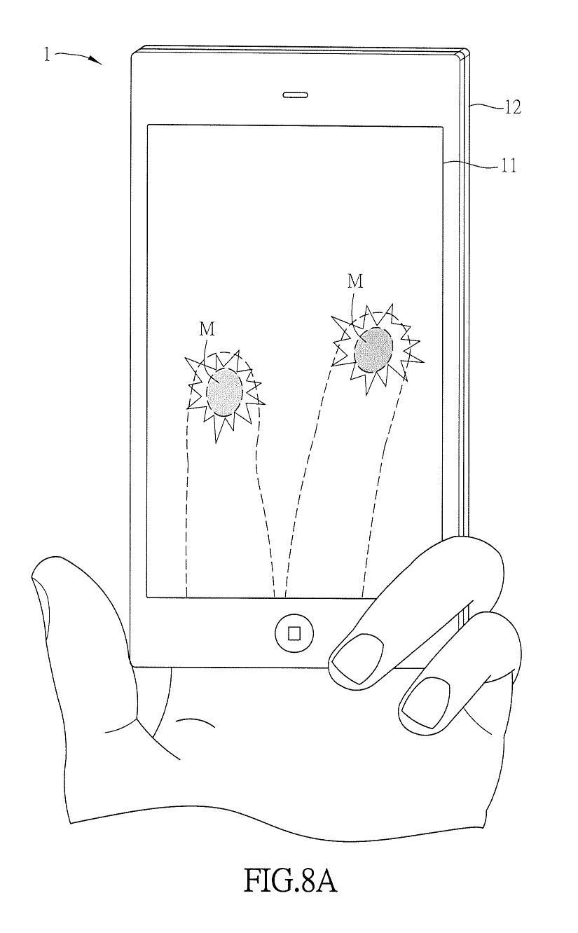

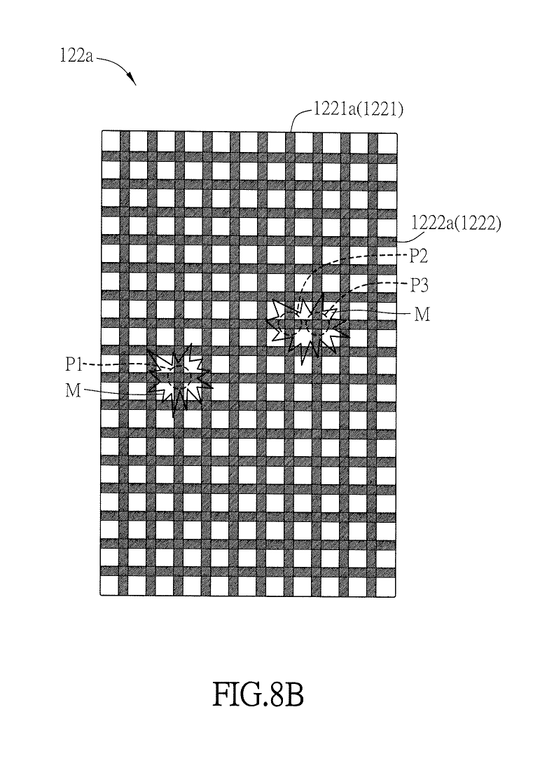

FIG. 7 is a flow chart showing the steps of the method for initiating multi-touch function according to one embodiment of the invention. FIG. 8A is a schematic diagram showing the trigger event according to one embodiment of the invention. FIG. 8B is a schematic diagram showing the trigger event in FIG. 8A corresponding to the touch-sensing structure in FIG. 4.

The method for initiating multi-touch function may be applied to not only the touch-sensing structure (self-capacitance) in FIG. 2, but also the touch-sensing structure (mutual capacitance) in FIG. 4. Here, only the touch-sensing structure 122a in FIG. 4 is explained, but the touch-sensing structure 122 in FIG. 2 can be analogous to it.

Referring to FIG. 7 to FIG. 8B, first in the step S10, trigger events M (as shown in FIG. 8A) is received by the touch-sensing structure 122a. The trigger events M trigger the part detective points P1, P2, P3 of the touch-sensing structure 122a. Here, the trigger event M may be an action that the user holds the hand-held electronic device 1. Because the user may be used to holding the hand-held electronic device 1 with the same gesture, the holding action by the user can be regarded as the trigger event M. Taking FIG. 8A for example, the user is used to holding the hand-held electronic device 1 by the forefinger and middle finger of the left hand at these positions. At the moment, the trigger events M trigger the part detective points P1, P2, P3 (as shown in FIG. 8B) on the touch-sensing cover 12. Namely, part of the first sensing lines 1221a will cause the capacitance variation resulting from the contact of the user during holding, and it can be regarded as a trigger. In other embodiment, the control unit 13 may compute the trigger quantity distribution, trigger time, trigger frequency, trigger morphology or trigger location of the detective points to generate a computational result. Taking FIG. 8B for example, the trigger quantity of the triggered detective points is three, the trigger quantity distribution of the triggered detective points is that P2 and P3 are close to each other and P1 is singly in another region, the morphology of the triggered detective points is that P1 is a single detective point and P2 and P3 are close to each other to form a strip of trigger region, the trigger locations of the triggered detective points are the location of P1, P2, P3.

Then in the step S20, the control unit 13 (as shown in FIG. 2) is utilized to determine whether the trigger event M conforms with the initiative determination condition stored in the hand-held electronic device 1. Concurrently referring to FIG. 2, in the embodiment, the hand-held electronic device 1 may further include a storage unit 15 which is electrically connected to the control unit 13. The storage unit 15 can store various instructions and program codes, and for example, it may be a flash memory, a ROM (read only memory), a RAM (random access memory), or other component capable of storing. In the embodiment, the storage unit 15 stores the initiative determination condition, and the content of the initiative determination condition relate to the manner that the user is used to holding the hand-held electronic device 1. Namely, the control unit 13 can determine whether the holding manner currently by the user conforms with the holding manner formerly by the user. In other embodiment, the control unit 13 determines whether the trigger quantity distribution, trigger time, trigger frequency, trigger morphology or trigger location of the triggered first sensing lines 1221a conforms with the initiative determination condition according to the computational result as previously mentioned.

In step S30, while the trigger event M conforms with the initiative determination condition, the capacitance detection unit 14 detects or starts to detect a plurality of the touch events occurring simultaneously at distinct positions on the cover 121 and generates a plurality of signals representing the positions where the respective touch events occur. Specifically, if the control unit 13 determines that the trigger event M conforms with the initiative determination condition, namely the holding manner currently by the user conforms with the holding manner formerly by the user, the control unit 13 will initiate the capacitance detection unit 14 into detecting or starting to detect a plurality of the touch events (T1, T2 as shown in FIG. 1) occurring simultaneously at distinct positions on the cover 121 and generate a plurality of signals representing the positions where the respective touch events occur. Thus, the multi-touch is implemented. As to the multi-touch, it can refer to the previous description, and it is not repeated again here.

Supplementarily (referring to FIG. 1 and FIG. 2), if the trigger morphology indicates multiple area contacts (which refer to contacts with 2D plane or 3D space), it is determined not to conform with the initiative determination condition. Here, multiple means more than two. In the embodiment, “area contact” means that the diameter of a single touch region on the touch-sensing cover 12 which the user contacts or the longest distance from one touch edge to the other touch edge is longer than 7 mm. The above configuration is based on the condition that it is easy to generate the trigger morphology indicating multiple area contacts when the user does not perform touch operation on the hand-held electronic device 1 and he only simply holds the hand-held electronic device 1, and thus such the trigger event is determined not to conform with the initiative determination condition.

Besides, in an embodiment the trigger morphology of the trigger event may indicate single area contact, and the determination of the initiation can be determined according to the position of the single area contact. For example, if the position of the single area contact is located at the upper half of the hand-held electronic device 1, it is determined not to conform with the initiative determination condition. The above configuration is based on the condition that when the user regularly holds the hand-held electronic device 1 and utilizes his finger to perform touch operation on the touch-sensing cover 12, the palm of the user may form a trigger region of area contact on the lower half of the hand-held electronic device 1, and the trigger region of area contact is not formed on the upper half. The diameter of the touch region formed on the upper half by the touch-sensing cover 12 and the finger performing the touch operation or the longest distance from one touch edge to the other touch edge is usually not longer than 7 mm. When the position of the single area contact is located at the upper half of the hand-held electronic device 1, it is very possible that the user does not perform touch operation but for example wipes the cover 121 or merely holds the hand-held electronic device 1. Here, to distinguish between the upper half and the lower half can depend on the center of the cover 121 or the center of the touch-sensing structure, and it still depends on actual situation when the user operates the hand-held electronic device. The portion upper than the center is regarded as the upper half, and the portion lower than the center is regarded as the lower half.

Besides, in some embodiments, the hand-held electronic device 1 further includes a NFC (near field communication) unit which has a NFC chip and an antenna. The NFC chip is electrically connected to the control unit, and the antenna is disposed on the cover 121 or the touch-sensing structure 122. When the user want to utilize the hand-held electronic device 1 to perform near field communication with another electronic device, he can take the hand-held electronic device 1 close to another electronic device capable of near field communication, so the antenna and the NFC chip are utilized to transmit or receive the electrical data to or from another electronic device.

In summary, the touch-sensing cover according to the invention includes the cover and the touch-sensing structure, the touch-sensing structure is disposed on the cover and includes a first sensing layer. The first sensing layer has a plurality of first sensing lines which include the detective points and are coupled to a capacitance detection unit. The touch-sensing structure receives a trigger event, and the trigger event triggers part of the detective points. While the trigger event conforms with an initiative determination condition stored in the hand-held electronic device, the capacitance detection unit detects or starts to detect a plurality of the trigger events occurring simultaneously at distinct positions on the cover, and generates a plurality of signals representing the positions where the respective trigger events occur. Thus the multi-touch function is implemented.

By determining whether the trigger event conforms with an initiative determination condition and then accordingly initiating the multi-touch function, it can prevent the hand-held electronic device from being unlocked and misappropriation by others. It can also improve safety by the trigger event as identification.

In addition, benefiting from the touch-sensing cover, the user can avoid performing touch operation on the display surface of the panel, so that the display panel and the software target displayed by the panel will not be shaded by user's fingers, and the user will not inadvertently suffer problems of opening the link due to high information content density on the display panel. Regardless of the user viewing the complete screen content to improve visual quality, the password will not be peeped by others behind the user when inputting it. It can reduce the cost of the touch-sensing structure, and improves efficiency, safety and operational convenience. It achieves better quality and user experience, and prevents the panel from being scratched by fingernail or stylus.

Furthermore, when the user uses the hand-held electronic device under the sun, he can hold the hand-held electronic device by his single hand and use the touch-sensing cover to block the sunlight or light source. Due to the panel information resulting from the touch-sensing cover blocking the sunlight, the sunlight visibility of the panel is improved, and it can be implemented without advanced OLED or electric paper display panel technique. In addition, because the user can just use single hand to operate or input respect to the panel information on the touch-sensing cover, it enhances safety of the hand-held electronic device and convenience of operation by single hand under the sun.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch-sensing cover for a hand-held electronic device having the touch-sensing cover, a panel and a control unit, comprising:
a cover, disposed on the other side of the hand-held electronic device opposite to the panel; and
a touch-sensing structure, with its partial or full area disposed on the cover and having a plurality of detective points to receive a trigger event triggering part of the detective points, wherein the touch-sensing structure comprising:
a first sensing layer, having a plurality of first sensing lines, wherein the first sensing lines comprise the detective points and are coupled to a capacitance detection unit,
wherein while the trigger event conforms with an initiative determination condition stored in the hand-held electronic device, the capacitance detection unit detects a plurality of the touch events occurring simultaneously at distinct positions on the cover, and generates a plurality of signals representing the positions where the respective touch events occur.

2. The touch-sensing cover of claim 1, wherein the touch-sensing structure further comprises a second sensing layer disposed separately from the first sensing layer in space, the second sensing layer has a plurality of second sensing lines, and the first sensing lines and the second sensing lines are respectively interlaced to form the detective points.

3. The touch-sensing cover of claim 2, wherein the first sensing layer further comprises a first substrate, the first sensing lines are disposed on the first substrate, the second sensing layer further comprises a second substrate, and the second sensing lines are disposed on the second substrate.

4. The touch-sensing cover of claim 2, wherein the first sensing lines are disposed on the cover, and there is an insulation layer between the first sensing layer and the second sensing layer.

5. The touch-sensing cover of claim 1, wherein the touch-sensing structure comprises a metal mash, a metal nanowire, a conductive film, a carbon nanotube and graphene.

6. A hand-held electronic device, comprising:
a panel;
a control unit, electrically connected to the panel; and
a touch-sensing cover, electrically connected to the control unit, comprising:
a cover, disposed on the other side of the hand-held electronic device opposite to the panel; and
a touch-sensing structure, with its partial or full area disposed on the cover and having a plurality of detective points to receive a trigger event triggering part of the detective points, wherein the touch-sensing structure comprising:
a first sensing layer, having a plurality of first sensing lines, wherein the first sensing lines comprise the detective points and are coupled to a capacitance detection unit,
wherein while the trigger event conforms with an initiative determination condition stored in the hand-held electronic device, the capacitance detection unit detects a plurality of the touch events occurring simultaneously at distinct positions on the cover, and generates a plurality of signals representing the positions where the respective touch events occur.

7. The hand-held electronic device of claim 6, wherein the control unit computes the trigger quantity distribution, trigger time, trigger frequency, trigger morphology or trigger location of the part of the detective points triggered by the trigger event to generate a computational result.

8. The hand-held electronic device of claim 7, wherein the control unit determines whether the trigger quantity distribution, trigger time, trigger frequency, trigger morphology or trigger location conforms with the initiative determination condition according to the computational result.

9. The hand-held electronic device of claim 6, wherein the touch-sensing structure further comprises a second sensing layer disposed separately from the first sensing layer in space, the second sensing layer has a plurality of second sensing lines, and the first sensing lines and the second sensing lines are respectively interlaced to form the detective points.

10. The hand-held electronic device of claim 9, wherein the first sensing layer further comprises a first substrate, the first sensing lines are disposed on the first substrate, the second sensing layer further comprises a second substrate, and the second sensing lines are disposed on the second substrate.

11. The hand-held electronic device of claim 6, wherein the touch-sensing structure comprises a metal mash, a metal nanowire, a conductive film, a carbon nanotube and graphene.

12. The hand-held electronic device of claim 6, wherein a user operates the hand-held electronic device by one hand, and the touch-sensing cover faces a light source or the back of the panel faces the light source.

13. The hand-held electronic device of claim 6, wherein the wires connected to the touch-sensing structure are concentrated in an outlet of one side.

14. The hand-held electronic device of claim 6, wherein the width of the touch-sensing structure is slightly narrower about 5% to 10% than the width of the touch-sensing cover.

15. The hand-held electronic device of claim 6, wherein the area of the touch-sensing structure has a ratio relationship to the area of the panel, and the control unit changes an input position of the touch-sensing structure to a display position of the panel according to the ratio relationship.

16. The hand-held electronic device of claim 6, wherein the first sensing layer or the second sensing layer is capable of wireless power transmission.

17. The hand-held electronic device of claim 6, wherein the touch-sensing cover further comprises a near field communication unit, the near field communication unit has a near field communication chip and an antenna, the near field communication chip is electrically connected to the control unit, and the antenna is disposed on the cover or the touch-sensing structure.

18. A method for initiating multi-touch function, adapted for a hand-held electronic device comprising a panel, a touch-sensing cover and a control unit, wherein the touch-sensing cover has a cover and a touch-sensing structure, the touch-sensing structure has a plurality of detective points and is coupled to a capacitance detection unit, the method executed on the hand-held electronic device comprises:
receiving a trigger event by the touch-sensing structure, wherein the trigger event triggers part of the detective points of the touch-sensing structure;
determining whether the trigger event conforms with the initiative determination condition stored in the hand-held electronic device by the control unit; and
while the trigger event conforms with the initiative determination condition, detecting a plurality of the touch events occurring simultaneously at distinct positions on the cover and generating a plurality of signals representing the positions where the respective touch events occur by the capacitance detection unit.

19. The method of claim 18, further comprising:
utilizing the control unit to compute the trigger quantity distribution, trigger time, trigger frequency, trigger morphology or trigger location of the part of the detective points triggered by the trigger event to generate a computational result.

20. The method of claim 19, wherein the control unit determines whether the trigger quantity distribution, trigger time, trigger frequency, trigger morphology or trigger location conforms with the initiative determination condition according to the computational result.
